(19) United States
(12) Patent Application Publication
(10) Pub. No.: US 2018/0354297 A1
(43) Pub. Date: Dec. 13, 2018

(54) TRACTION DEVICE FOR A VEHICLE WITH DUAL WHEELS

(71) Applicant: John A. Couillard, Sherwood, ND (US)

(72) Inventor: John A. Couillard, Sherwood, ND (US)

(21) Appl. No.: 16/004,535

(22) Filed: Jun. 11, 2018

Related U.S. Application Data
(60) Provisional application No. 62/518,235, filed on Jun. 12, 2017.

(51) Int. Cl. B60B 15/26

(52) U.S. Cl. CPC B60B 15/266; B60B 11/02

(57) ABSTRACT

A traction device for installation between a set of dual wheels on a vehicle, the traction device including a wheel attachment plate, at least one leg and at least one paddle. The wheel attachment plate is centrally coupled between each of the wheels. The at least one leg is coupled to the wheel attachment plate between the wheels. The at least one paddle is coupled to the leg and positioned radially outward from the wheel attachment plate.

### CROSS REFERENCE TO RELATED APPLICATIONS

This is a non-provisional application based upon U.S. provisional patent application Ser. No. 62/518,235, entitled “TRACTION DEVICE FOR A VEHICLE WITH DUAL WHEELS”, filed Jun. 12, 2017, which is incorporated herein by reference.

### BACKGROUND OF THE INVENTION

### 1. Field of the Invention

The present invention relates to traction enhancement devices, and, more particularly, to traction enhancement devices for dual wheeled vehicles.

### 2. Description of the Related Art

To enhance traction in areas with snow, mud, ice or other traction reducing conditions, chains or tire chains, are fitted to the tires of vehicles to provide maximum traction while driving in such an environment.

Tire chains (chains) attach to the drive wheels of a vehicle or an automated system can deploy chains by swinging them under the tires. Although named after steel chain, chains may be made of other materials and in a variety of patterns and strengths. Chains are usually sold in pairs and generally must be purchased to match a particular tire size. Driving with chains typically reduces fuel efficiency, and can reduce the allowable speed of the vehicle, but they increase traction and braking on snowy or icy surfaces, which is the primary reason they are used. Some regions require chains to be used under adverse weather conditions, but other areas prohibit the use of chains, as they can damage road surfaces.

Snow chains were invented in 1904 by Harry D. Weed who received U.S. Pat. No. 768,495 for his “Grip-Tread for Pneumatic Tires”. Most tire chains are wrapped around the circumference of the tires and are held in place with rim chains, which may be chain or cable, elastic or adjustable tensioners

Problems with chains are that drivers will try driving too fast, and they will drive on dry roads without removing the chains. The vehicle operator may improperly install the chains by not securing the chains tightly enough, or install the chains on non-drive wheels. If a chain does break, it can cause vehicle damage by rapidly slapping around inside the wheel well, or possibly wrapping around the axle and severing brake lines.

Alternatives to chains include studded tires, which are tires affixed with metal studs that are mounted into holes in the treads of the tire. Other traction devices include mud chains, which are similar to snow chains and are generally used for off-road, four-wheel drive applications, such as heavy off-road equipment like log skidders, which have to operate over very rough, muddy terrain. Wheel tracks are also used for added traction, which are heavy duty assemblies similar to chains but with rigid cross links such as sometimes used on logging equipment.

What is needed in the art is an easy to install and uninstall traction device that can be installed when the vehicle is stuck.

### SUMMARY OF THE INVENTION

The present invention provides a traction system that can be easily installed by the operator of a vehicle after getting stuck.

The invention in one form is directed to a traction device for installation between a set of dual wheels on a vehicle, the traction device including a wheel attachment plate, at least one leg and at least one paddle. The wheel attachment plate is centrally coupled between each of the wheels. The at least one leg is coupled to the wheel attachment plate between the wheels. The at least one paddle is coupled to the leg and positioned radially outward from the wheel attachment plate.

The invention in another form is directed to a traction system for a vehicle including a dual wheeled drive having two sets of dual wheels and a traction device installed on each of the two sets of dual wheels the traction device including a wheel attachment plate, at least one leg and at least one paddle. The wheel attachment plate is centrally coupled between each of the wheels. The at least one leg is coupled to the wheel attachment plate between the wheels. The at least one paddle is coupled to the leg and positioned radially outward from the wheel attachment plate.

An advantage of the present invention is that the attachment plates are unobtrusively positioned between the sets of dual wheels.

Another advantage is that the traction paddles provide incredible traction for the vehicle.

Yet another advantage is that the easy coupling and decoupling of the traction devices from the adaptor plate reduce the need for towing of the vehicle and the associated downtime.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a semi-tractor and trailer using an embodiment of a traction device of the present invention;

FIG. 2 is a perspective view of one set of driving dual wheels of the semi-tractor of FIG. 1, with one traction paddle of the present invention installed on the dual wheels;

FIG. 3 is a perspective view of the dual wheel traction device of FIGS. 1 and 2, being illustrated apart from the dual wheels;

FIG. 4 is an end view of a wheel attachment plate that is a part of the dual wheel traction device of FIGS. 1-3;

FIG. 5 is a perspective view of the leg illustrated in FIG. 4, which is a part of the dual wheel traction device of FIGS. 1-3;

FIG. 6 is a perspective view of a locking pin used in the dual wheel traction device of FIGS. 1-3; and

FIG. 7 is a perspective view of a paddle of the dual wheel traction device of FIGS. 1-3.

Corresponding reference characters indicate corresponding parts throughout the several views. The exemplification set out herein illustrates an embodiment of the invention, and such exemplification is not to be construed as limiting the scope of the invention in any manner.

### DETAILED DESCRIPTION OF THE INVENTION

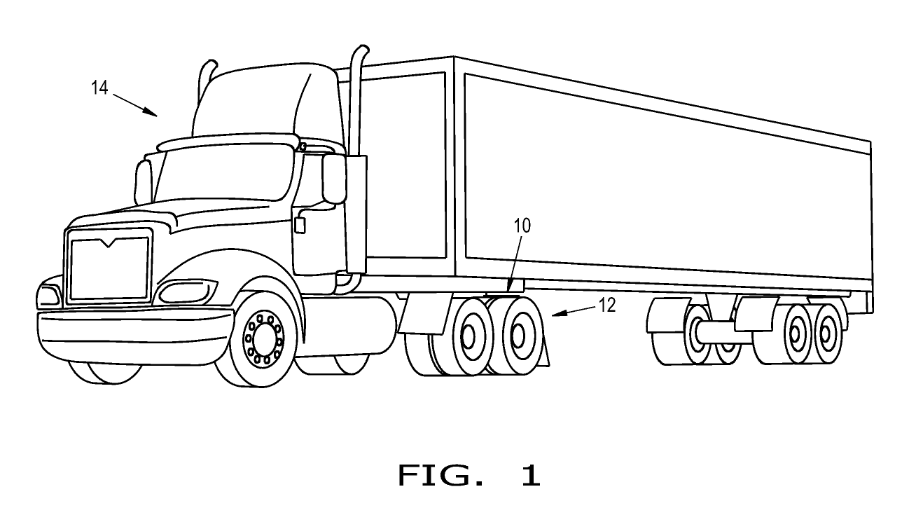

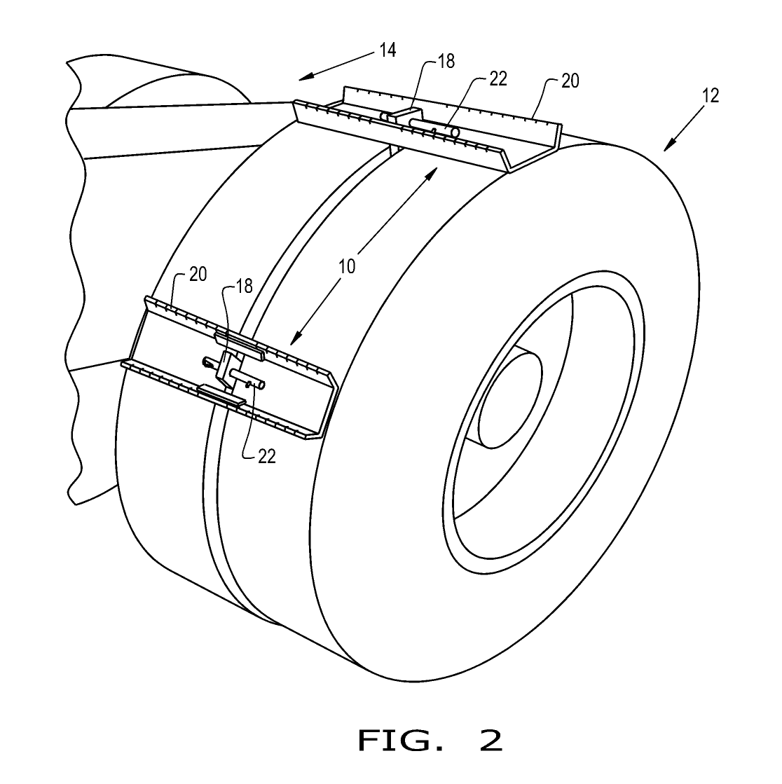

Referring now to the drawings and more particularly to FIGS. 1 and 2, there is shown an embodiment of a dual wheel traction device 10 installed on a dual wheel assembly 12 of a semi-tractor 14.

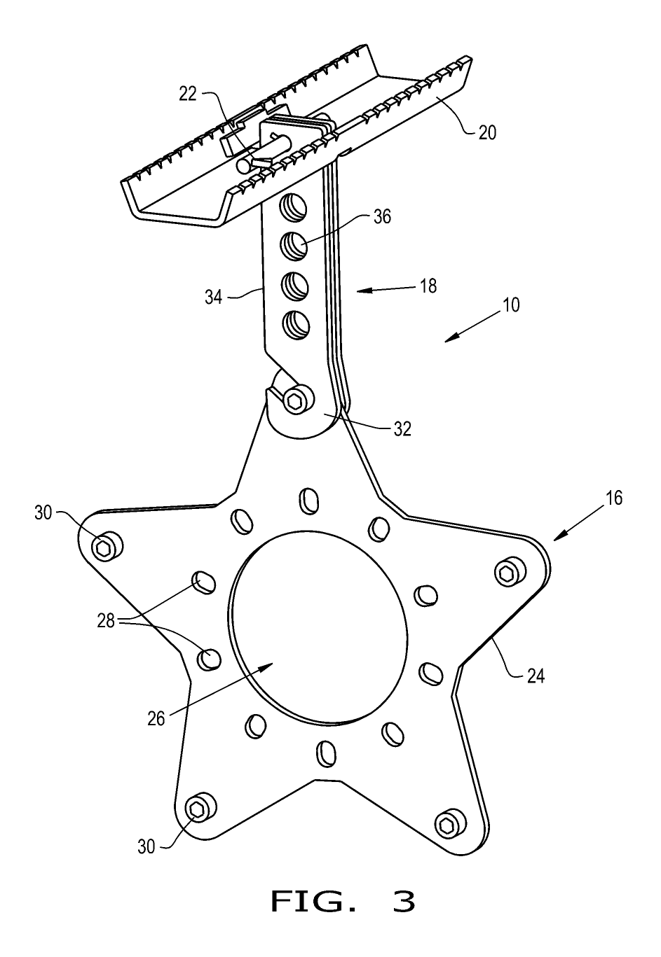

Now, additionally referring to FIG. 3 there is shown elements of traction device 10 including a wheel attachment plate 16, a leg 18, a paddle 20 and a lock pin 22. Although only one leg 18, one paddle 20 and one lock pin 22 are illustrated, for the ease of understanding, in this example, it can be understood that up to five of each of these can be coupled to wheel attachment plate 16. It is also contemplated that some number other than five coupling points on wheel attachment plate 16 can be provided.

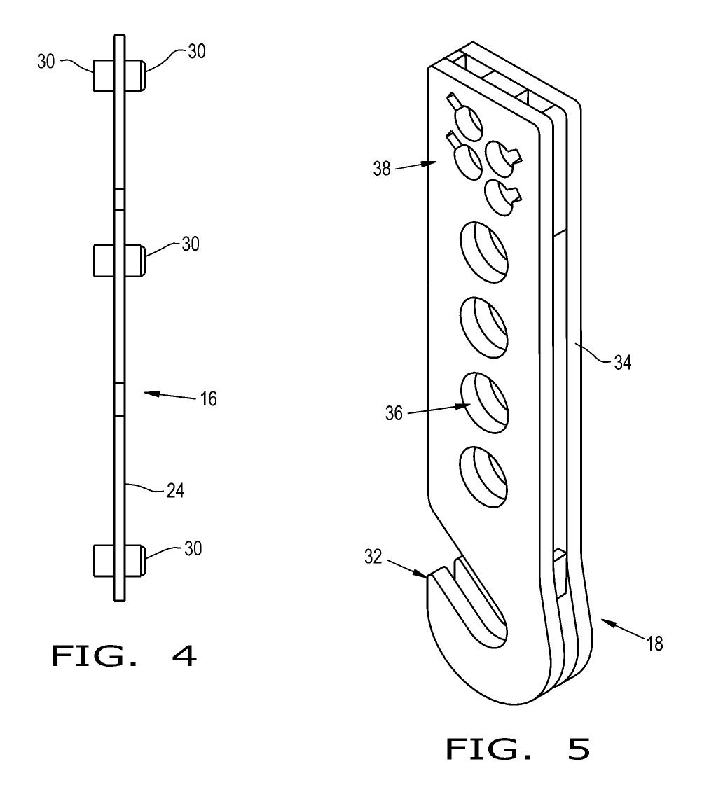

Now, additionally referring to FIGS. 3 and 4, wheel attachment plate 16 includes a main body 24, a central opening 26, a plurality of holes 28 and coupling protrusions 30. Main body 24 is a plate 24 that, in this embodiment, is star shaped, although other shapes are also contemplated. Central opening 26 is sized to accommodate a wheel hub upon which wheel assembly 12 is coupled. Holes 28 are sized and positioned to accommodate lug bolts that extend though the wheels of wheel assembly 12. Coupling protrusions 30 extend from both sides of plate 24. Plate 24 has a thickness that allows unobtrusive installation between the wheels of wheel assembly 12. Plate 24 can be installed and left between the wheels for unobtrusive use of vehicle 10, but the coupling of legs 18, paddles 20 and locking pins 22 can easily be enabled when needed by the operator.

Now, additionally referring to FIG. 5, there is shown a perspective view of leg 18 having a hook 32, a body 34, with holes 36 and holes 38 therein. Hook 32 is sized and shaped to accommodate a quick, yet secure coupling to protrusions 30 when the use of traction device 10 is needed. Hook 32, as can be seen is actually two parallel hooks that couple to protrusions 30 on each side of plate 24. Holes 38 are shaped, positioned and sized to accommodate the insertion of locking pin 22.

Now, additionally referring to FIG. 6 there is illustrated some additional details of locking pin 22 that has a pin member 40, an orientation pin 42 and a wedging protrusion 44. When paddle 20 is inserted over leg 18 pin 22 is inserted into a selected hole 38 to secure paddle 20 to leg 18. Pin member 40 is first inserted into hole 38 and is rotated so the pin 42 will slide through the keyed opening of hole 38. After pin 42 has transitioned though the keyed opening, then pin 22 is rotated approximately 90° to prevent pin 42 from escaping hole 38, while in use. It is also contemplated to use other locking devices to secure leg 18 to paddle 20. The selection of a hole 38 is done such that hook 32 will then not be able to disengage from protrusions 30.

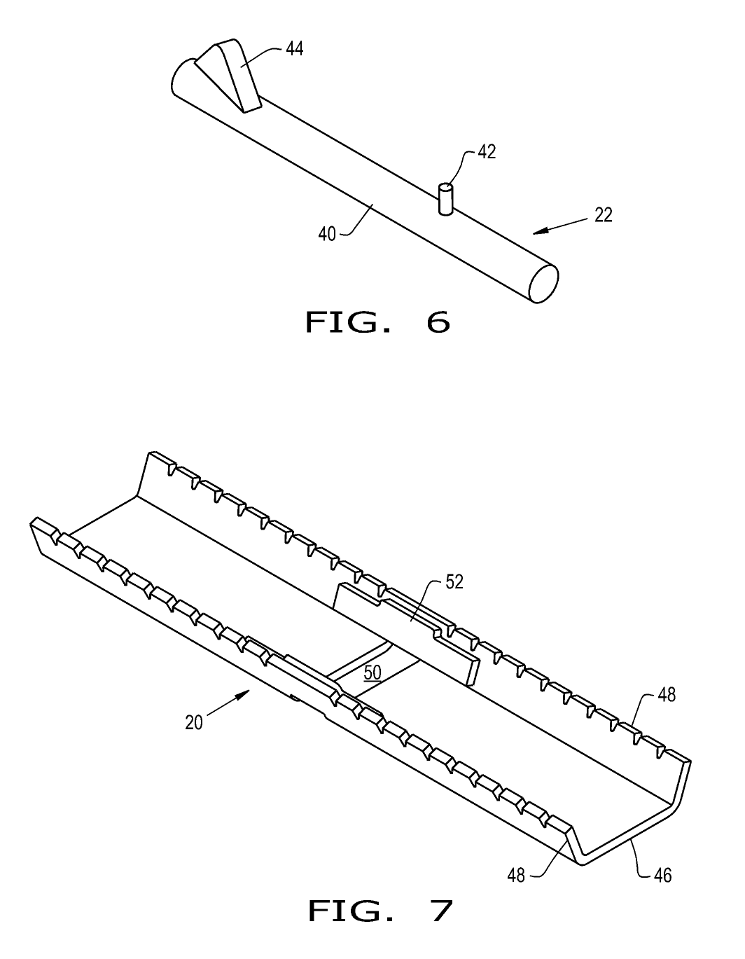

Now, additionally referring to FIG. 7 there is illustrated some of the features of paddle 20, which has a lateral member 46 and two traction protrusions 48 extending therefrom. A slot 50 extends through a central portion of lateral member 46 and two reinforcing plates 52 are positioned along a portion of traction protrusions 48 proximate to slot 50. Slot 50 accommodates the extension of leg 18 therethrough.

To install wheel attachment plate 16, remove the outside wheel of wheel assembly 12 and from vehicle 14. Slide wheel attachment plate 16 onto the wheel lug bolts. Then reinstall the outside wheel back onto vehicle 14. Torque the lug nuts to the recommended torque. When vehicle 14 is stuck, then install legs 18 between the dual tires and slip grab hook 32 onto protrusions 30, which can be the head of a socket bolt on one side of attachment 16 and a round nut on the other side. Slide paddle 20 using hole 50 over leg 18 so that the tire paddle 20 sits on both tires. Pull on leg 18 and install tire paddle lock pin 22 through one of the four adjusting holes 38 that is closest to the top surface of tire paddle 20 with the small pin 42 on lock pin 22 going through the slot in hole 38 of leg 18. Turn tire paddle lock pin 22 so that the flange 44 on the end of lock pin 22 sits flush onto tire paddle 20. As many paddles 20, legs 18 and lock pins 22 can be used on wheel assembly 12 as needed, and a similar installation on a drive dual wheel assembly on the opposite side of the vehicle can be undertaken. Then the vehicle can be operated to ensure that it is unstuck, then lock pins 22, paddles 20 and legs 18 are removed and stowed, and the operator can proceed on the journey.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A traction system for a vehicle, comprising:
a dual wheeled drive having two sets of dual wheels; and
a traction device installed on each of the two sets of dual wheels, the traction device including:
a wheel attachment plate centrally coupled between each of the sets of dual wheels;
at least one leg coupled to the wheel attachment plate; and
at least one paddle, the paddle being coupled to the leg and positioned radially outward from the wheel attachment plate.

2. The traction system for a vehicle of claim 1, wherein the traction device further comprises a locking pin inserted through the leg thereby securing the paddle to the leg.

3. The traction system for a vehicle of claim 1, wherein the at least one leg is a plurality of legs each coupled to the wheel attachment plate.

4. The traction system for a vehicle of claim 3, wherein the at least one paddle is a plurality of paddles with each of the plurality of paddles being associated with a corresponding one of the legs.

5. The traction system for a vehicle of claim 4, wherein the paddles each have an opening therein allowing the corresponding leg to extend therethrough.

6. The traction system for a vehicle of claim 5, wherein the traction device further comprises a plurality of locking pins with each corresponding locking pin being inserted through a corresponding one of the legs thereby securing the corresponding paddle to the leg.

7. The traction system for a vehicle of claim 6, wherein each locking pin includes a wedging protrusion that encounters either a portion of the paddle or a portion of the leg to thereby wedge the locking pin in position.

8. The traction system for a vehicle of claim 1, wherein the wheel attachment plate includes a plurality of coupling protrusions, the at least one leg having a hook-like end that hooks over one of the coupling protrusions.

9. The traction system for a vehicle of claim 8, wherein each coupling protrusion extends from both sides of the wheel attachment plate, the hook-like end straddling the plate and engaging the coupling protrusion on both sides of the wheel attachment plate.

10. A traction device for installation between a set of dual wheels on a vehicle, the traction device comprising:
a wheel attachment plate centrally coupled between each of the wheels of the set of dual wheels;
at least one leg coupled to the wheel attachment plate; and
at least one paddle, the paddle being coupled to the leg and positioned radially outward from the wheel attachment plate.

11. The traction device of claim 10, further comprising a locking pin inserted through the leg thereby securing the paddle to the leg.

12. The traction device of claim 10, wherein the at least one leg is a plurality of legs each coupled to the wheel attachment plate.

13. The traction device of claim 12, wherein the at least one paddle is a plurality of paddles with each of the plurality of paddles being associated with a corresponding one of the legs.

14. The traction device of claim 13, wherein the paddles each have an opening therein allowing the corresponding leg to extend therethrough.

15. The traction device of claim 14, wherein the traction device further comprises a plurality of locking pins with each corresponding locking pin being inserted through a corresponding one of the legs thereby securing the corresponding paddle to the leg.

16. The traction device of claim 15, wherein each locking pin includes a wedging protrusion that encounters either a portion of the paddle or a portion of the leg to thereby wedge the locking pin in position.

17. The traction device of claim 10, wherein the wheel attachment plate includes a plurality of coupling protrusions, the at least one leg having a hook-like end that hooks over one of the coupling protrusions.

18. The traction device of claim 17, wherein each coupling protrusion extends from both sides of the wheel attachment plate, the hook-like end straddling the plate and engaging the coupling protrusion on both sides of the wheel attachment plate.

19. A method of installing a traction device on a set of dual wheels of a vehicle, the method comprising the steps of:
positioning a wheel attachment plate between the two wheels of the set of dual wheels;
inserting a leg between the two wheels and coupling the leg to the wheel attachment plate; and
coupling a paddle to the leg.

20. The method of claim 19, further comprising the steps of:
repeating the inserting step with another leg; and
repeating the coupling step with another paddle.
